(19) United States
(12) Patent Application Publication
(10) Pub. No.: US 2013/0127276 A1
(43) Pub. Date: May 23, 2013

(54) HYDRODYNAMIC BEARING ASSEMBLY AND MOTOR INCLUDING THE SAME

(71) Applicant: Sang Jae SONG, Suwon (KR)

(72) Inventor: Sang Jae SONG, Suwon (KR)

(73) Assignee: SAMSUNG ELECTRO-MECHANICS CO., LTD., Suwon (KR)

(21) Appl. No.: 13/616,877

(22) Filed: Sep. 14, 2012

(30) Foreign Application Priority Data
Nov. 17, 2011 (KR) 10-2011-0120238

(51) Int. Cl. F16C 32/06; H02K 7/08

(52) U.S. Cl. 310/90; 384/100

(57) ABSTRACT

There are provided a hydrodynamic bearing assembly and a motor including the same. The hydrodynamic bearing assembly includes: a sleeve having a shaft rotatably inserted therein; a hub provided on an upper end of the shaft and having a main wall part protruding downwarly in an axial direction; and a stopper provided at an inner side of the main wall part to limit floatation of the hub and form an oil interface between an inner surface thereof in an inner radial direction and an outer surface of the sleeve, wherein the stopper has a lower porosity in a portion filled with oil than that of other portions thereof.

### CROSS-REFERENCE TO RELATED APPLICATIONS

This application claims the priority of Korean Patent Application No. 10-2011-0120238 filed on Nov. 17, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a motor including the same.

2. Description of the Related Art

A hard disk drive (HDD), an information storage device, reads data stored on a disk or writes data to a disk using a read/write head.

The hard disk drive requires a disk driving device capable of driving the disk. In the disk driving device, a small-sized motor is used.

In the small-sized motor, a hydrodynamic bearing assembly has been used. A shaft, a rotating member of the hydrodynamic bearing assembly, and a sleeve, a fixed member thereof, have oil interposed therebetween, such that the shaft is supported by fluid pressure generated in the oil.

Further, in the spindle motor including the hydrodynamic bearing assembly, a fluid sealing part is configured using surface tension of the fluid and a capillary phenomenon. In the sealing part, stability is an important factor.

However, when an external impact is applied to the spindle motor in a state in which the spindle motor is being driven or is stopped, a phenomenon in which the lubricating fluid forming a lubricating fluid interface is leaked to the outside occurs, causing a loss of lubricating fluid, thereby deteriorating driving stability of the spindle motor.

Therefore, research into a technology for preventing the leakage of lubricating fluid when an external impact is applied to a spindle motor and allowing the lubricating fluid to be reintroduced toward a lubricating fluid interface even though the lubricating fluid is leaked, thereby improving driving stability of motor has been urgently demanded.

### SUMMARY OF THE INVENTION

An aspect of the present invention provides a motor including a sintered stopper provided in a portion in which an oil interface is formed and allowing a portion of the sintered stopper filled with oil to have a lower porosity than that of other portions thereof, to thereby enable oil that would otherwise be leaked to be absorbed by the portion having high porosity.

According to an aspect of the present invention, there is provided a hydrodynamic bearing assembly including: a sleeve having a shaft rotatably inserted therein; a hub provided on an upper end of the shaft and having a main wall part protruding downwarly in an axial direction; and a stopper provided at an inner side of the main wall part to limit floatation of the hub and form an oil interface between an inner surface thereof in an inner radial direction and an outer surface of the sleeve, wherein the stopper has a lower porosity in a portion filled with oil than that of other portions thereof.

The stopper may be a sintered stopper.

A boundary at which the porosity is changed may be a position to which the oil interface maximally descends, downwardly in the axial direction in the stopper.

The sleeve may include a catching portion provided at an upper end thereof and protruding in an outer radial direction to allow the stopper to be caught.

At least one of the inner surface of the stopper and the outer surface of the sleeve between which the oil interface is formed is tapered such that an interval between the stopper and the sleeve may widen downwardly in the axial direction.

According to another aspect of the present invention, there is provided a motor including: a hydrodynamic bearing assembly including a sleeve having a shaft rotatably inserted therein; a hub provided on an upper end of the shaft and having a main wall part protruding downwarly in an axial direction; and a stopper provided at an inner side of the main wall part to limit floatation of the hub and form an oil interface between an inner surface thereof in an inner radial direction and an outer surface of the sleeve, the stopper having a lower porosity in a portion filled with oil than that of other portions thereof; a stator coupled to an outer portion of the sleeve and including a core having a coil wound therearound in order to generate rotational driving force; and a hub fixed to the shaft so as to be rotatable with respect to the stator and including a magnet mounted on one surface thereof, the magnet facing the coil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor according to an embodiment of the present invention; and

FIG. 2 is a schematic cross-sectional view showing a dynamic bearing assembly according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

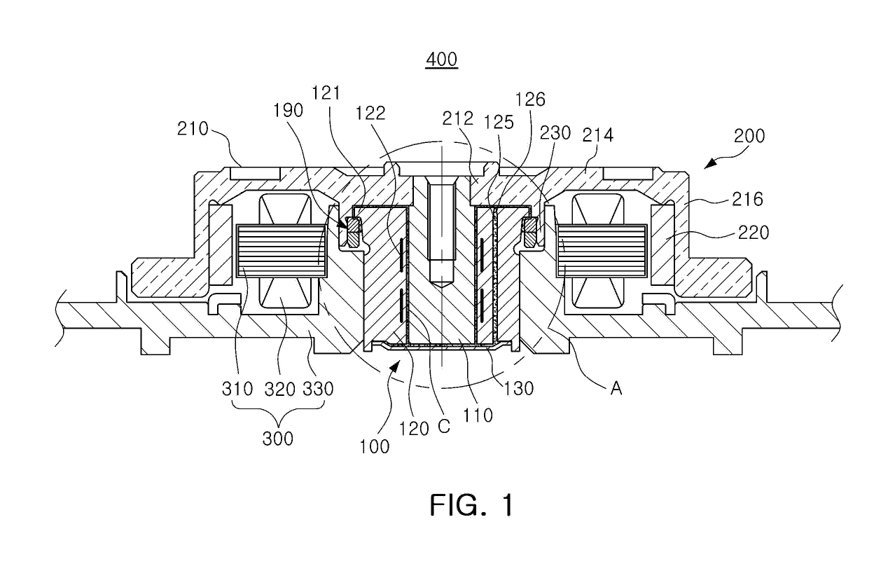

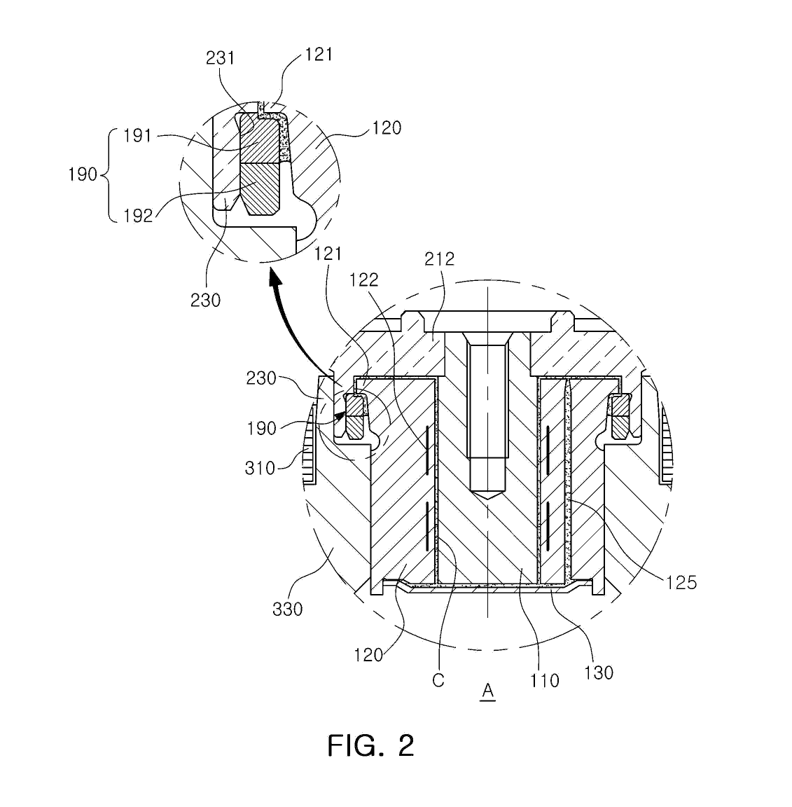

FIG. 1 is a schematic cross-sectional view showing a motor according to an embodiment of the present invention; and FIG. 2 is a schematic cross-sectional view showing a dynamic bearing assembly according to the embodiment of the present invention.

Referring to FIGS. 1 and 2, a motor 400 according to the embodiment of the present invention may include a hydrodynamic bearing assembly 100 including a shaft 110 and a sleeve 120, a rotor 200 including a hub 210, and a stator 300 including a core 310 having a coil 320 wound therearound.

The hydrodynamic bearing assembly 100 may include the shaft 110, the sleeve 120, a stopper 190, and the hub 210, and the hub 210 may be a component configuring the hydrodynamic bearing assembly 100 while configuring the rotor 200 to be described below.

Terms with respect to directions will first be defined. As viewed in FIG. 1, an axial direction refers to a vertical direction based on the shaft 110, and an outer radial direction and an inner radial direction refer to a direction toward an outer edge of the hub 210 based on the shaft 110 and a direction toward the center of the shaft 110 based on the outer edge of the hub 210, respectively.

The sleeve 120 may support the shaft 110 so that an upper end of the shaft 110 protrudes upwardly in the axial direction.

The sleeve 120 may be formed by sintering a Cu—Fe-based alloy powder or an SUS-based powder.

In this configuration, the shaft 110 may be inserted into a shaft hole of the sleeve 120 to have a micro clearance serving as a bearing clearance C between the shaft 110 and the shaft hole of the sleeve 120. The bearing clearance may be filled with oil, and rotation of the rotor 200 may be more smoothly supported by a radial dynamic pressure groove 122 formed in at least one of an outer diameter of the shaft 110 and an inner diameter of the sleeve 120.

The radial dynamic pressure groove 122 may be formed in an inner side of the sleeve 120, an inner portion of the shaft hole of the sleeve 120, and generate pressure so that the shaft 110 may rotate in a state in which the shaft 111 is spaced apart from the sleeve 110 by a predetermined interval at the time of rotation thereof.

However, the radial dynamic pressure groove 122 is not limited to being formed in the inner side of the sleeve 120 as described above, but may also be formed in an outer diameter portion of the shaft 110. In addition, the number of radial dynamic pressure grooves 122 is not limited.

Here, the radial dynamic pressure groove 122 may have at least one of a herringbone shape, a spiral shape, and a screw shape. However, the radial dynamic pressure groove 122 may have any shape as long as radial dynamic pressure may be generated thereby.

The sleeve 120 may include a circulation hole 125 formed therein so as to allow upper and lower portions thereof to be in communication with each other. The circulation hole 125 may disperse pressure of the oil in the hydrodynamic bearing assembly 100 to maintain balance in pressure and allow air bubbles, or the like, present in the hydrodynamic bearing assembly 100 to move so as to be discharged by circulation.

Here, the sleeve 120 may include a catching portion 121 provided at an upper end thereof and protruding in the outer radial direction to allow the stopper 190 to be described below to be caught, thereby limiting floating of the shaft 110 and the rotor 200.

Further, the sleeve 120 may include a base cover 130 coupled thereto at a lower portion thereof in the axial direction, while having a clearance therebetween, the clearance receiving oil therein.

The base cover 130 may receive the oil in the clearance between the base cover 130 and the sleeve 120 to serve as a bearing supporting a lower surface of the shaft 110.

The hub 210, a rotating member coupled to the shaft 110 and rotating together with the shaft 110, may configure the rotor 200, while configuring the hydrodynamic bearing assembly 100. Hereinafter, the rotor 200 will be described in detail.

The rotor 200 may be a rotating structure provided to be rotatable with respect to the stator 300 and include the hub 210 having an annular ring-shaped magnet 220 provided on an outer peripheral surface thereof, wherein the annular ring-shaped magnet 220 corresponds to a core 310 to be described below, having a predetermined interval therebetween.

In other words, the hub 210 may be a rotating member coupled to the shaft 110 to rotate together with the shaft 110.

Here, as the magnet 220, a permanent magnet generating magnetic force having a predetermined strength by alternately magnetizing an N pole and an S pole thereof in a circumferential direction may be used.

In addition, the hub 210 may include a first cylindrical wall part 212 fixed to an upper end of the shaft 110, a disk part 214 extended from an end portion of the first cylindrical wall part 212 in the outer radial direction, and a second cylindrical wall part 216 protruding downwardly from an edge portion of the disk part 214 in the outer radial direction. The second cylindrical wall part 216 may include the magnet 220 coupled to an inner peripheral surface thereof.

The hub 210 may have a main wall part 230 extended downwardly in the axial direction so as to correspond to an outer portion of the upper portion of the sleeve 120.

Here, the main wall part 230 may include the stopper 190 provided at an inner side thereof, and the stopper 190 may limit floatation of the hub 210 and form an oil interface between an inner surface thereof in the inner radial direction and an outer surface of the sleeve 120.

In addition, the inner surface of the stopper 190 may be tapered such that an interval between the inner surface of the stopper 190 and the outer surface of the sleeve 120 may widen downwardly in the axial direction to facilitate the sealing of the oil. Further, the outer surface of the sleeve 120 may also be tapered to facilitate the sealing of the oil.

Further, the stopper 190 may have a lower porosity in a fluid contact part 191, which is a portion filled with the oil, than in an air contact part 192, which is a portion other than the fluid contact part 191. The stopper 190 may be a sintered sleeve manufactured in a sintering scheme.

Here, a boundary at which the porosity is changed may be a position to which the oil interface maximally descends, downwardly in the axial direction, in the stopper 190. That is, a boundary between the fluid contact part 191 and the air contact part 192 may coincide with the position to which when the oil interface maximally descends downwardly in the axial direction in the stopper 190. This position means a position of the oil interface in a processing of filling a fluid at the time of manufacturing of the motor.

Meanwhile, the main wall part 230 may have a step part 231 on which the stopper 190 is seated.

The stator 300 may include the coil 320, the core 310, and the base member 330.

In other words, the stator 300 may be a fixed structure including the coil 320 generating electromagnetic force having a predetermined magnitude at the time of application of power and a plurality of cores 310 having the coil 320 wound therearound.

The core 310 may be fixedly disposed on an upper portion of the base member 330 including a printed circuit board (not shown) having pattern circuits printed thereon, the upper surface of base member 330 corresponding the winding coil 330 may be provided with a plurality of coil holes having a predetermined size and penetrating through the base member 330 so as to expose the winding coil 320 downwardly, and the winding coil 320 may be electrically connected to the printed circuit board (not shown) such that external power is supplied thereto.

The outer peripheral surface of the sleeve 120 may be fixed to the base member 330 and the core 310 having the coil 320 wound therearound may be inserted into the base member 330. In addition, the base member 330 and the sleeve 120 may be assembled to each other by applying an adhesive to an inner surface of the base member 330 or the outer surface of the sleeve 120.

As set forth above, according to the hydrodynamic bearing assembly and the motor including the same according to the embodiment of the present invention, the sintered sleeve is used, whereby the leakage of the fluid can be effectively prevented.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a sleeve having a shaft rotatably inserted therein;
a hub provided on an upper end of the shaft and having a main wall part protruding downwarly in an axial direction; and
a stopper provided at an inner side of the main wall part to limit floatation of the hub and form an oil interface between an inner surface thereof in an inner radial direction and an outer surface of the sleeve,
wherein the stopper has a lower porosity in a portion filled with oil than that of other portions thereof.

2. Thy hydrodynamic bearing assembly of claim 1, wherein the stopper is a sintered stopper.

3. Thy hydrodynamic bearing assembly of claim 1, wherein a boundary at which the porosity is changed is a position to which the oil interface maximally descends, downwardly in the axial direction in the stopper.

4. Thy hydrodynamic bearing assembly of claim 1, wherein the sleeve includes a catching portion provided at an upper end thereof and protruding in an outer radial direction to allow the stopper to be caught.

5. Thy hydrodynamic bearing assembly of claim 1, wherein at least one of the inner surface of the stopper and the outer surface of the sleeve between which the oil interface is formed is tapered such that an interval between the stopper and the sleeve widens downwardly in the axial direction.

6. A motor comprising:
a hydrodynamic bearing assembly including a sleeve having a shaft rotatably inserted therein; a hub provided on an upper end of the shaft and having a main wall part protruding downwarly in an axial direction; and a stopper provided at an inner side of the main wall part to limit floatation of the hub and form an oil interface between an inner surface thereof in an inner radial direction and an outer surface of the sleeve, the stopper having a lower porosity in a portion filled with oil than that of other portions thereof;
a stator coupled to an outer portion of the sleeve and including a core having a coil wound therearound in order to generate rotational driving force; and
a hub fixed to the shaft so as to be rotatable with respect to the stator and including a magnet mounted on one surface thereof, the magnet facing the coil.
